(19) United States
(12) Patent Application Publication
(10) Pub. No.: US 2007/0278363 A1
(43) Pub. Date: Dec. 6, 2007

(54) COLLAPSIBLE DOOR PAINTING SUPPORT STAND

(76) Inventor: Kevin Klippel, Canyon Country, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/420,942

(22) Filed: May 30, 2006

(51) Int. Cl. F16M 11/00

(52) U.S. Cl. 248/157

(57) ABSTRACT

The present invention includes a portable, collapsible door painting support stand having a base, a ground-engaging vertical support extending upwardly from the base, a plurality of legs attached to the vertical support and selectively pivotable between a first ground-engaging position and a second folded position, and a pivot arm extending generally horizontally from the vertical support. A door to be painted is disposed between the base and the pivot arm.

### BACKGROUND OF THE INVENTION

The present invention generally relates to a device for holding objects. More particularly, the present invention resides in a device for holding objects to be painted.

Devices for holding objects to be painted are generally known in the art. For example, U.S. Pat. No. 5,090,648 discloses stand assembly for rotationally holding a door, window frame or the like, for painting purposes. However, the disclosed stand is not collapsible for easy portability or storage of the stand. The bottom support of the stand also extends outwardly in a number of directions that can obstruct or even trip a user. In another example, U.S. Pat. No. 5,164,011 discloses a door painting fixture for holding a door in a generally vertical position with the door being supported for rotational movement. However, the disclosed fixture is also not collapsible for easy portability or storage of the fixture. The bottom support of the fixture also extends outwardly in a number of directions that can obstruct or even trip a user.

Accordingly, there is a need for a support stand that is collapsible. There is a further need for a support stand that is portable. There is an additional need for a support stand that is easily foldable between operational and collapsed configurations. There is also a need for a stand that relies on minimal support for maintaining an upright configuration. There is a need for a support stand that is economical and easy to manufacture. The present invention fulfills these needs and provides other related advantages.

### SUMMARY OF THE INVENTION

The present invention resides in a support stand that is easily foldable between operational and collapsed configurations, providing a support stand that is collapsible and portable. The support stand has a simplified structure for maintaining the support in an upright configuration.

The present invention discloses a portable, collapsible door painting support stand having a base, a ground-engaging vertical support extending upwardly from the base,

a plurality of legs attached to the vertical support and selectively pivotable between a first ground-engaging position and a second folded position, and a pivot arm extending generally horizontally from the vertical support. A door to be painted is disposed between the base and the pivot arm.

The vertical support includes a telescoping extension selectively movable between a first retracted position and a second extended position. The telescoping extension includes a locking mechanism for holding the extension at and/or between the first and second positions, and for releasing the extension for moving between the first and second positions.

Each leg of the stand includes a stabilizing end for engaging the ground. Each leg also includes a lock for holding the pivotal legs in the first position. The base is selectively pivotable between a first ground-engaging position and a second folded position. A pivot projection extends upwardly from the base and is pivotally movable between a first retracted position and a second extended position.

The pivot arm is selectively pivotable between a first door-engaging position and a second folded position.

Other features and advantages of the present invention will become apparent from the following more detailed description, taken in conjunction with the accompanying drawings which, by way of example, illustrate the principles of the invention.

### BRIEF DESCRIPTION OF THE DRAWINGS

The accompanying drawings illustrate the invention. In such drawings:

FIG. 1 is a perspective view of a door painting support stand embodying the present invention, shown in a collapsed, folded configuration;

FIG. 2 is a perspective view of the door painting support stand of FIG. 1 shown in a partially opened configuration; and

FIG. 3 is a perspective view of the door painting support stand of FIG. 1 shown in an opened configuration, supporting a door.

### DETAILED DESCRIPTION OF THE PREFERRED EMBODIMENT

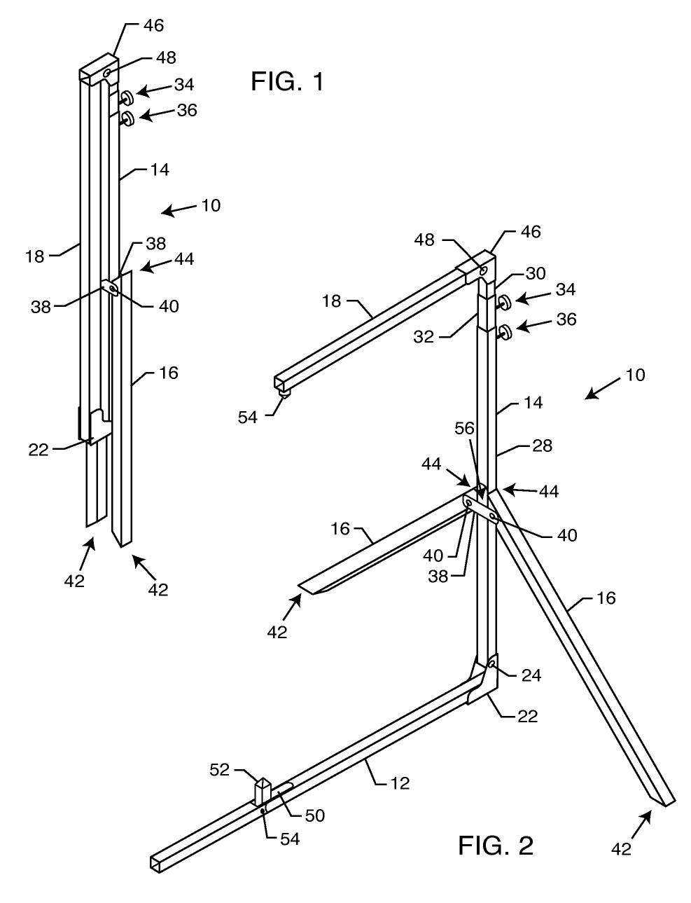

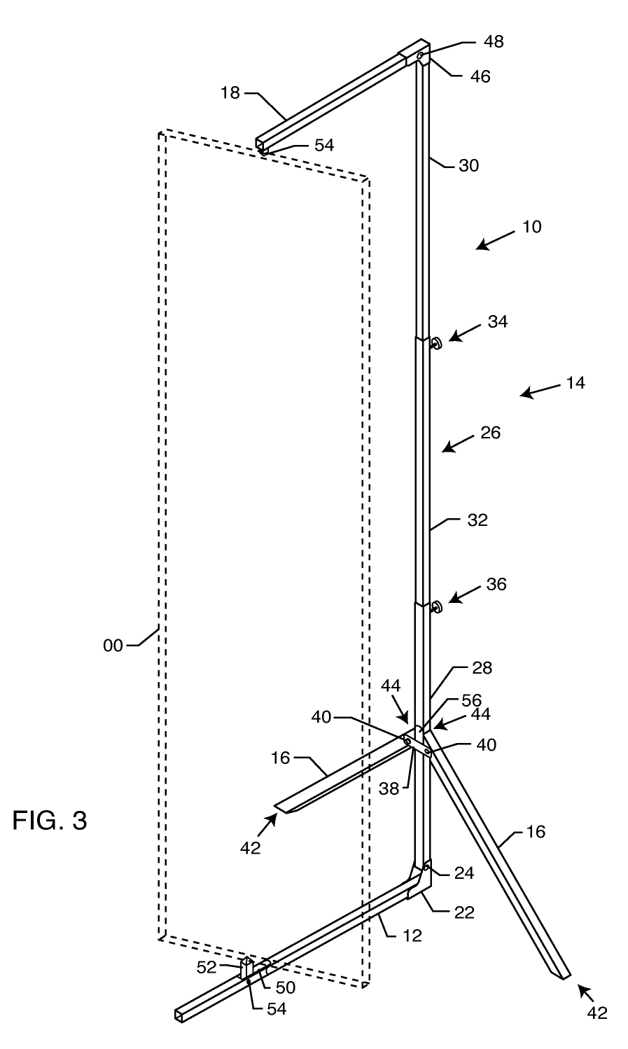

As shown in the drawings for purposes of illustration, the present invention discloses a portable, collapsible door painting support stand 10, as seen in FIGS. 1-3. The door painting support stand 10 includes a base 12, a ground-engaging vertical support 14, a plurality of legs 16, and a pivot arm 18. A door 20 to be painted is disposed between the base 12 and the pivot arm 18.

The base 12 is selectively pivotable between a first ground-engaging position and a second folded position where one side of the base 12 is adjacent to the vertical support 14. In an opened configuration, the vertical support 14 extends upwardly from the base 12. The base 12 and the vertical support 14 are each connected to a bracket 22 that allows the base 12 and vertical support 14 to pivot relative to one another between open and folded configurations. Whether the base 12 is positioned on a ground surface or held above the ground surface, the vertical support can be raised from the folded position to the opened position by pivoting the vertical support 14 relative to the base 12 via a pivot pin 24 extending through the bracket 22.

The ground-engaging vertical support 14 includes a telescoping extension section 26 including a lower portion 28, an upper portion 30 and an intermediate portion 32 disposed therebetween. The extension section 26 allows the vertical support 14 to be selectively movable between at least a completely retracted position and a fully extended position. The upper portion 30 is slidably receivable within the intermediate portion 32. A locking mechanism 34 holds and/or releases the upper portion 30 to move relative to the intermediate portion 32, between retracted and extended positions. Likewise, the intermediate portion 32 is slidably receivable within the lower portion 28. A locking mechanism 36 holds and/or releases the intermediate portion 32 to move relative to the lower portion 28, between retracted and extended positions. Each locking mechanisms 34, 36 uses a turnable knob connected to a threaded shank that extends through a threaded bore (not shown) in the intermediate 32 and lower 28 portions, respectively. An end of the threaded shank of each locking mechanism 34, 36 abuts against a respective portion 30, 32 when the knob is turned in one direction to lock the portion 30, 32 in place relative to the respective portion 32, 28 from which the portion 30, 32 moves relative to. Turning the knob in the other direction releases the portions 30, 32 to move relative to their respective portions 32, 28.

The plurality of legs 16 are attached to the lower portion 28 of the vertical support 14. A pair of brackets 38, each located on an opposite side of the vertical support 14, allow the legs 16 to selectively pivot between ground-engaging (i.e., open) and folded positions. Before the base 12 is positioned on a ground surface, the legs 16 are moved from their folded to their opened positions by pivoting the legs 16 relative to the vertical support 14 via pivot pins 40 extending through the legs 16 and brackets 38.

Each leg 16 includes an angled stabilizing end 42, distal from the vertical support 14, for engaging the ground surface. Each leg 16 also includes an angled locking end 44 for locking the pivotal legs in the opened position. In the opened position, the angled ends 42, 44 of the legs 16 are generally parallel and adjacent to the ground surface and the vertical support 14, respectively. When the angled locking ends 44 of the legs 16 contact the surface of the vertical support 14, the legs 16 can not pivot any further and are locked into position.

In an opened configuration, the pivot arm 18 extends generally horizontally away from the vertical support 14 and serves as a horizontal support for the door 20. The pivot arm 18 and the vertical support 14 are each connected to a bracket 46 that allows the pivot arm 18 and the vertical support 14 to pivot relative to one another between open and folded configurations. The pivot arm 18 can be raised from a folded position to an opened (i.e., door engaging) position by pivoting the pivot arm 18 relative to the upper portion 30 of the vertical support 14 via a pivot pin 48 extending through the bracket 46.

The base 12 includes a recess 50 from which a pivot projection 52 is pivotally movable between a folded, retracted position within the recess 50 and a vertical, extended position where the pivot projection 52 extends upwardly from the base 12. The pivot projection 52 is connected to the base 12 via a spring-loaded pin 54 extending through the recess 50 between opposite sides of the base 12.

The pivot arm 18 includes a pivot projection 54 extending away from pivot arm 18 and downwardly from the horizontal support 18 when the pivot arm 18 is in an opened position. The vertical support 14 includes a recess 56 into which the pivot projection 54 is received when the pivot arm 18 is moved from the opened position into a folded position adjacent the vertical support 14. The pivot projections 52, 54 allow the door 20 to be rotated about a vertical axis while supporting the door 20 in a generally vertical position when the pivot projections 52, 54, engage the upper and lower sides of the door 20.

In the alternative, the base 12 may include a telescoping extension section, similar to the extension section 26 of the vertical support 14, in order to allow the length of the base 12 to be adjusted.

While the support stand 10 has been described in terms of use with a door 20, the stand 10 is can also be used with other objects to be painted including, without limitation, window frames, portrait frames, shutters, chairs, benches, pieces of furniture or the like.

The above-described embodiment of the present invention is illustrative only and not limiting. It will thus be apparent to those skilled in the art that various changes and modifications may be made without departing from this invention in its broader aspects.

What is claimed is:

1. A portable, collapsible door painting support stand, comprising:
a base;
a ground-engaging vertical support extending upwardly from the base;
a plurality of legs attached to the vertical support and selectively pivotable between a first ground-engaging position and a second folded position; and
a pivot arm extending generally horizontally from the vertical support, wherein a door to be painted is disposed between the base and the pivot arm.

2. The stand of claim 1, wherein the vertical support includes a telescoping extension selectively movable between a first retracted position and a second extended position.

3. The stand of claim 2, wherein the telescoping extension includes a locking mechanism for holding the extension at and/or between the first and second positions, and for releasing the extension for moving between the first and second positions.

4. The stand of claim 1, wherein each leg includes a stabilizing end for engaging the ground.

5. The stand of claim 1, wherein each leg includes a lock for holding the pivotal legs in the first position.

6. The stand of claim 1, wherein the base is selectively pivotable between a first ground-engaging position and a second folded position.

7. The stand of claim 1, wherein the pivot arm is selectively pivotable between a first door-engaging position and a second folded position.

8. The stand of claim 1, including a pivot projection extending upwardly from the base.

9. The stand of claim 8, wherein the pivot projection is pivotally movable between a first retracted position and a second extended position.

10. A portable, collapsible door painting support stand, comprising:
a base selectively pivotable between a first ground-engaging position and a second folded position;
a ground-engaging vertical support including a telescoping extension selectively movable between a first retracted position and a second extended position, the vertical support extending upwardly from the base;
a plurality of legs attached to the vertical support and selectively pivotable between a first ground-engaging position and a second folded position; and
a pivot arm extending generally horizontally from the vertical support, wherein a door to be painted is disposed between the base and the pivot arm.

11. The stand of claim 10, wherein the telescoping extension includes a locking mechanism for holding the extension at and/or between the first and second positions, and for releasing the extension for moving between the first and second positions.

12. The stand of claim 10, wherein each leg includes a stabilizing end for engaging the ground.

13. The stand of claim 10, wherein each leg includes a lock for holding the pivotal legs in the first position.

14. The stand of claim 10, wherein the pivot arm is selectively pivotable between a first door-engaging position and a second folded position.

15. The stand of claim 10, including a pivot projection extending upwardly from the base.

16. The stand of claim 15, wherein the pivot projection is pivotally movable between a first retracted position and a second extended position.

17. A portable, collapsible door painting support stand, comprising:
a base selectively pivotable between a first ground-engaging position and a second folded position;
a ground-engaging vertical support including a telescoping extension selectively movable between a first retracted position and a second extended position, the vertical support extending upwardly from the base;
a plurality of legs attached to the vertical support and selectively pivotable between a first ground-engaging position and a second folded position; and
a pivot arm selectively pivotable between a first door-engaging position and a second folded position, extending generally horizontally from the vertical support, and wherein a door to be painted is disposed between the base and the pivot arm;
wherein the telescoping extension of the vertical support includes a locking mechanism for holding the extension at and/or between the first and second positions, and for releasing the extension for moving between the first and second positions.

18. The stand of claim 17, wherein each leg includes a stabilizing end for engaging the ground and a lock for holding the pivotal legs in the first position.

19. The stand of claim 17, including a pivot projection extending upwardly from the base, wherein the pivot projection is pivotally movable between a first retracted position and a second extended position.
